(19) United States
(12) Patent Application Publication
(10) Pub. No.: US 2019/0138776 A1
(43) Pub. Date: May 9, 2019

(54) BARCODE FOR HEADSTONES

(71) Applicant: Marc F. Jones, Mona, UT (US)

(72) Inventor: Marc F. Jones, Mona, UT (US)

(21) Appl. No.: 15/622,135

(22) Filed: Jun. 14, 2017

(51) Int. Cl. G06K 7/14; G06F 17/30

(52) U.S. Cl. CPC G06K 7/1413; G06Q 50/10; G06F 17/30

(57) ABSTRACT

Loving Memories is the only product of its kind that engages mourners by providing an instant account of their beloved lost ones by the simple use of a barcode-linked application. Loving Memories is uniquely designed to hopefully aid later generations so that individuals can have a glimpse at the joy and experiences shared by their great, great grandfathers and grandmothers, aunts and uncles and the like, even after their passing.

### BACKGROUND OF THE INVENTION

### Field of the Invention

The present invention is an object used for the representation of data. More specifically, the present invention is a barcode.

### Description of the Related Art

There are currently no feasible products on the market that offer a modern approach to remembering the deceased via an interactive application. Losing a loved one can be the hardiest experience an individual attempts to recover from. As time progresses, the challenge of holding onto the special memories and moments of that deceased person's life begin to fade often exacerbating the lost.

### SUMMARY OF THE INVENTION

The present invention is an object used for the representation of data. More specifically, the present invention is a barcode.

The barcode includes a data-supported barcode.

It is an object of the present invention to provide a barcode system that a user can use with a personalized mobile application that is intended to go on the headstone of a buried individual.

It is an object of the present invention to provide an instant reconnection to memories of the past.

It is an object of the present invention to provide a sticker type material that can be lacquered onto any headstone.

It is an object of the present invention to scan a specialized barcode to access a host of pictures, documented stories and other allow a visitor at a gravesite to use their mobile device, once the app has been downloaded, to media that helps to re-kindle the unique memories of that person's life before their passing.

It is an object of the present invention to provide a barcode that allows the complementary application to be uploaded and replenished by family members or dear friends further allowing for personalized memories to be added to the collection of noted accomplishments and other memorabilia.

It is an object of the present invention to provide a barcode system that can be used with a complimentary application that can be readily available on any App store for iPhone™ or Android™ devices.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a headstone with a barcode, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

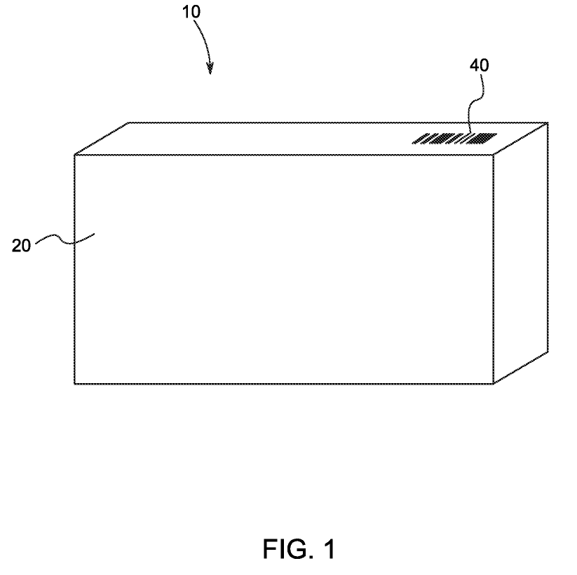

Referring now to FIG. 1, illustrated is a front view of a headstone with a barcode 10, in accordance with one embodiment of the present invention.

In FIG. 1A, illustrated is a front view of the headstone with a barcode 10, including a body 20 and a barcode 40.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

1-6. (canceled)

7. A headstone, comprising:
a body to be placed adjacent to a grave of a deceased person; and
a barcode disposed on a surface of the body, the barcode having encoded therein information related to the deceased person, such that the information is accessible via a mobile application running on a mobile device in response to the mobile device scanning the barcode, such that the information encoded within the barcode is updated in response to new information being uploaded from the mobile application.

8. The headstone of claim 7, wherein the mobile application is opened in response to the mobile device scanning the barcode.
